(19) United States
(12) Patent Application Publication
(10) Pub. No.: US 2026/0298213 A1
(43) Pub. Date: Oct. 1, 2026

(54) GEOTHERMAL AND GEOPRESSURE RECOVERY SYSTEMS

(71) Applicant: Sage Geosystems Inc., Houston, TX (US)

(72) Inventors: Douglas SIMPKINS, Houston, TX (US); Lev M. RING, Bellaire, TX (US); Robert Lance COOK, Houston, TX (US); Michael HILL, The Woodlands, TX (US); Nathan WEISS, Bellaire, TX (US)

(21) Appl. No.: 19/480,328

(22) PCT Filed: May 2, 2024
(86) PCT No.: PCT/US2024/027346

§ 371 Date: Oct. 30, 2025

Related U.S. Application Data
(63) Continuation-in-part of application No. PCT/US2024/025455, filed on Apr. 19, 2024.
(60) Provisional application No. 63/499,883, filed on May 3, 2023.

(51) Int. Cl. F03G 4/00; F04F 13/00

(52) U.S. Cl. CPC F03G 4/001; F04F 13/00

(57) ABSTRACT

A geothermal power system includes a pressure exchanger fluidically coupled to a heat exchanger. A first fluid enters the pressure exchanger at a first inlet, and flows in a first fluid path to a first outlet. The first fluid flows from the first outlet to the heat exchanger, where the first fluid heats a second fluid. The first fluid flows from the heat exchanger to a second inlet of the pressure exchanger. The first fluid flows in a second fluid path through the pressure exchanger to a second outlet. A pressure of the first fluid reduces as the first fluid transits through the pressure exchanger along the first fluid path. A pressure of the first fluid increases as the first fluid transits through the pressure exchanger along the second fluid path. The first fluid flows from the second outlet to a turbine which drives a generator.

### CROSS-REFERENCE TO RELATED APPLICATIONS

This application is an International Patent Application under the Patent Cooperation Treaty and claims priority to and the benefit of: U.S. Provisional Patent Application Ser. No. 63/499,883 filed May 3, 2023, titled Geothermal and Geopressure Recovery Systems; and International Patent Cooperation Treaty Application PCT/US2024/025455 filed Apr. 19, 2024 and titled Pressure and Temperature Recovery Systems for Geothermal Power Plants. The disclosures of each of U.S. Provisional Patent Application Ser. No. 63/499,883 and International Patent Cooperation Treaty Application PCT/US2024/025455 are incorporated herein in their entireties by this reference.

### BACKGROUND

### Field

Embodiments of the present disclosure generally relate to geothermal power systems and processes, and particularly to the recovery of geothermal heat energy and pressure energy to perform useful work, such as generating electricity.

### Description of the Related Art

Geothermal energy is a type of renewable energy generated within the earth. A geothermal fluid (such as water, steam, brine, or hydrocarbons) is heated in a subterranean geological formation by the earth's natural internal temperature. The heated geothermal fluid is produced to the earth's surface. The enthalpy of the geothermal fluid includes a heat energy component and a pressure-volume energy component. Typically, the heat energy component is greater than the pressure-volume energy component. At the earth's surface, the heat energy component is used to perform useful work, such as heating buildings or generating electricity in a geothermal power system. However, the pressure-volume energy component is usually wasted, such as by venting. After performing useful work, the geothermal fluid is reinjected into the subterranean formation, reheated by the subterranean formation, then produced again to the earth's surface to perform useful work.

Some geothermal power systems generate electricity by using the geothermal fluid to drive a steam turbine. However, where the produced geothermal fluid is at or below about 180 degrees C., geothermal power systems typically incorporate a binary cycle power plant to generate electricity. A heat exchanger of the binary cycle power plant transfers heat, but not pressure, from the geothermal fluid to a working fluid of the binary cycle power plant.

In an example, operation of the binary cycle power plant is based on the Brayton Cycle, in which the heated working fluid passes through a turbine, which drives a generator. In another example, operation of the binary cycle power plant is based on the Organic Rankine Cycle, in which the heated working fluid passes through an expander, which drives a generator. Typically, binary cycle power plants utilize only the heat energy component of the enthalpy of the geothermal fluid. The pressure-volume energy component is wasted, such as by venting.

The efficiency of a geothermal power system depends on the amount of energy (in the form of heat energy and pressure-volume energy) that can be transferred from the subterranean geological formation to the geothermal fluid, and depends on the proportion of that energy that is converted into useful work. Typically, the efficiency of converting geothermal energy (in the form of heat energy plus pressure-volume energy) into electricity is less than 15 percent.

Thus, there is a need for improved systems and processes that facilitate the conversion of geothermal energy into electricity.

### SUMMARY

The present disclosure generally relates to geothermal power systems and processes, and particularly to the recovery of geothermal heat energy and pressure energy to perform useful work, such as generating electricity. In one implementation, a method of operating a geothermal power system includes flowing a first fluid into a first inlet of a pressure exchanger, and flowing the first fluid from a first outlet of the pressure exchanger to a heat exchanger. The method further includes flowing the first fluid from the heat exchanger to a second inlet of the pressure exchanger, flowing the first fluid from a second outlet of the pressure exchanger to a turbine coupled to a generator, and generating electricity using the generator.

In another implementation, a method of operating a geothermal power includes simultaneously flowing a first fluid and a second fluid such that the first fluid passes through a pressure exchanger and then through a heat exchanger, and the second fluid passes through the heat exchanger and then through the pressure exchanger. The method further includes transferring heat from the first fluid to the second fluid at the heat exchanger, and reducing a pressure of the first fluid at the pressure exchanger by increasing a pressure of the second fluid at the pressure exchanger. The method further includes flowing the second fluid from the pressure exchanger to an expander coupled to a generator, operating the expander to reduce the pressure and a temperature of the second fluid, and generating electricity using the generator.

In another implementation, a geothermal power system includes a heat exchanger fluidically coupled to a pressure exchanger. The pressure exchanger is configured such that a first fluid enters the pressure exchanger at a first inlet, and transits through the pressure exchanger in a first fluid path from the first inlet to a first outlet. The heat exchanger receives the first fluid from the first outlet of the pressure exchanger, and the pressure exchanger receives the first fluid from the heat exchanger at a second inlet of the pressure exchanger. The pressure exchanger is further configured such that the first fluid transits through the pressure exchanger in a second fluid path from the second inlet to a second outlet. The second fluid path is separate from the first fluid path. The geothermal power system further includes a turbine fluidically coupled to the second outlet of the pressure exchanger, and a first generator coupled to the turbine.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1A schematically illustrates a geothermal power system.

FIG. 1B schematically illustrates a manifold assembly that may be incorporated into the geothermal power system of FIG. 1A.

FIG. 1C schematically illustrates process flows for a single well that may be used with the geothermal power system of FIG. 1A.

FIG. 1D schematically illustrates a flowline assembly that may be used with the geothermal power system of FIG. 1A.

FIG. 2 schematically illustrates a geothermal power system.

FIG. 3 schematically illustrates a geothermal power system.

FIG. 4 is a flow diagram of a method of operating a geothermal power system.

FIG. 5 is a flow diagram of a method of operating a geothermal power system.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns geothermal power systems and processes, and particularly to the recovery of geothermal energy to perform useful work, such as generating electricity.

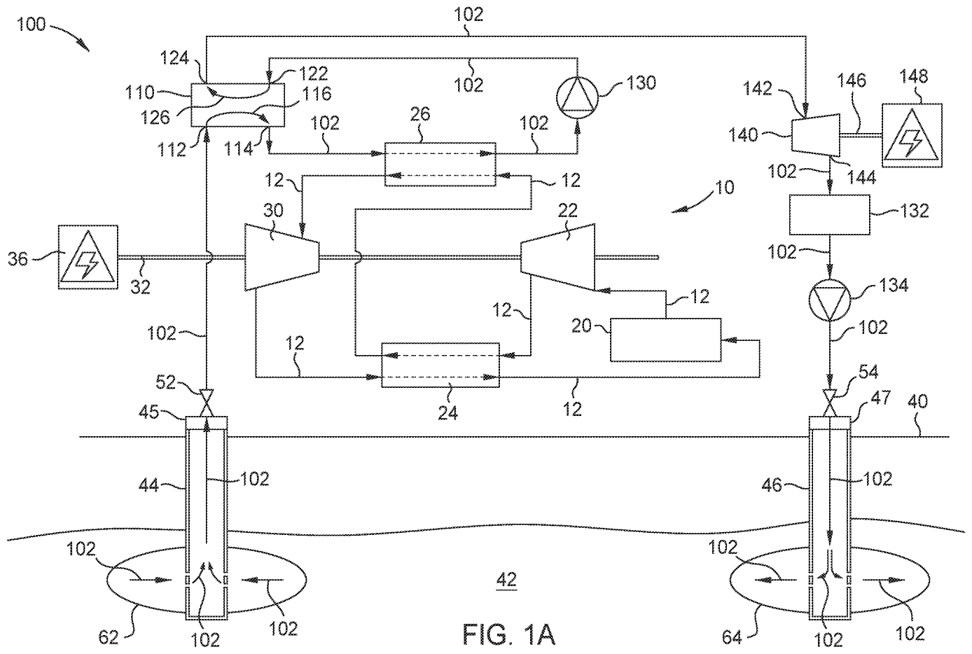

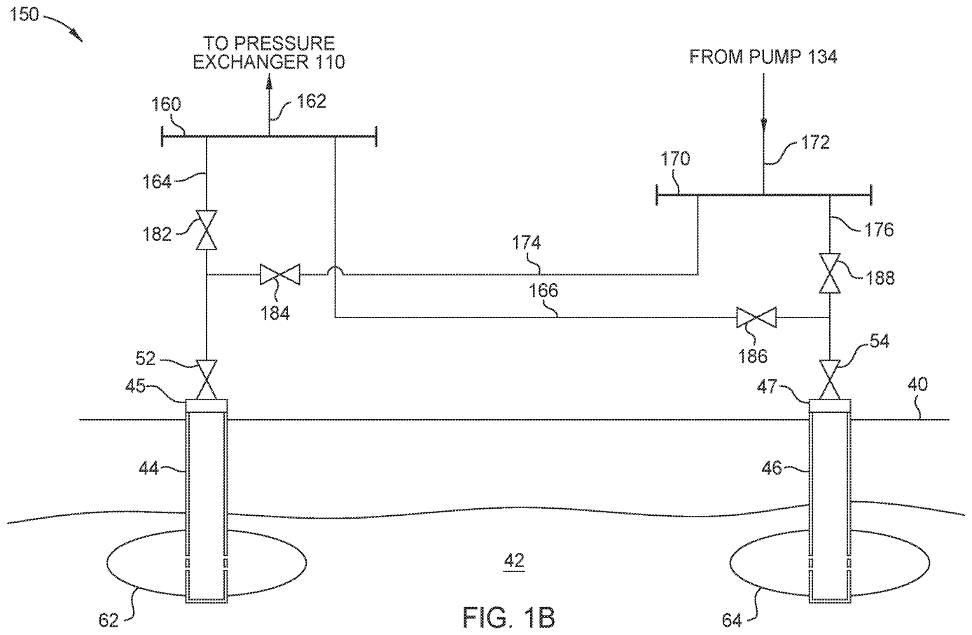

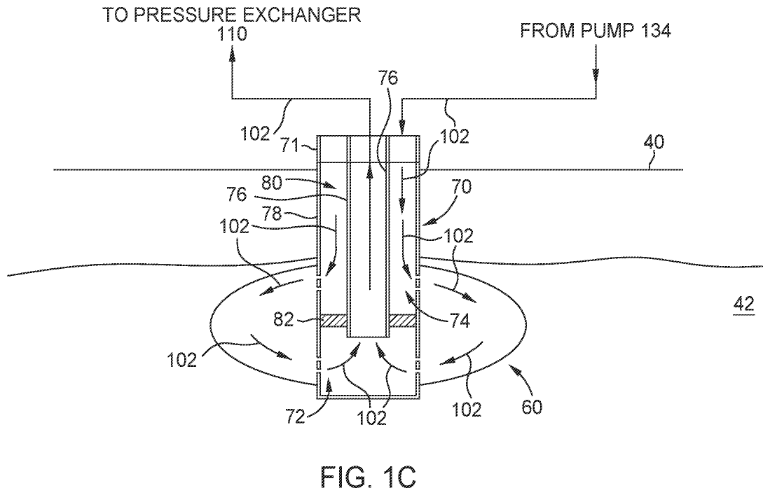

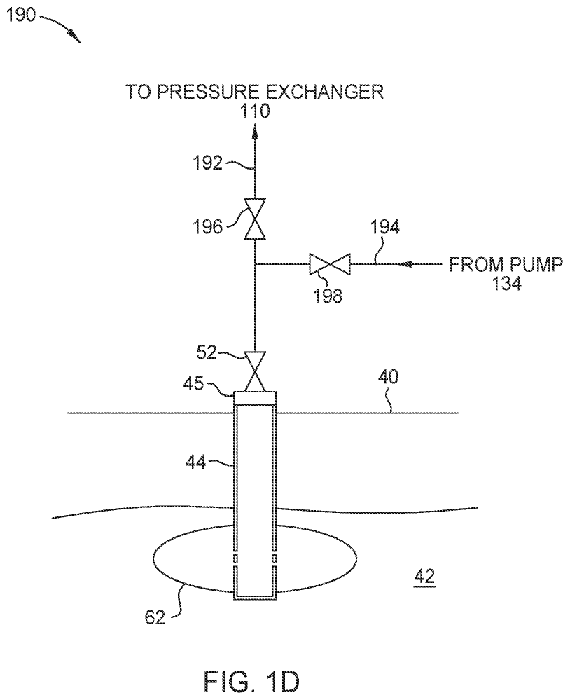

FIG. 1A schematically illustrates a geothermal power system 100. The geothermal power system 100 includes a binary cycle power plant 10. In some embodiments, operation of the binary cycle power plant 10 is based on the Brayton Cycle. In some embodiments, operation of the binary cycle power plant 10 is based on the Rankine Cycle. In some embodiments, operation of the binary cycle power plant 10 is based on the Organic Rankine Cycle.

The binary cycle power plant 10 utilizes a working fluid (represented by arrows 12), such as water, steam, brine, a refrigerant, a supercritical fluid, carbon dioxide, ammonia, an organic compound (e.g., a hydrocarbon, a fluorocarbon, etc.), or any combination thereof. The working fluid 12 flows from a condenser 20 to a pressure booster 22, such as a pump (e.g. a single phase pump, a multi-phase pump, a centrifugal pump, or a positive displacement pump), a compressor, or the like. The pressure booster 22 increases the pressure of the working fluid 12, and moves the working fluid 12 through a recuperator 24 to a heat exchanger 26, where the working fluid 12 is heated. Exemplary types of heat exchanger 26 include concurrent flow, counter-flow, shell and tube, paraflow plate, and the like.

The heated working fluid 12 then flows to an expander 30, such as a turbine, a turbo-expander, or the like. The working fluid 12 drives the expander 30 to rotate a shaft 32. The shaft 32 is coupled to a generator 36. In an example, the shaft 32 is coupled to the generator 36 via a gearbox. The shaft 32 drives the generator 36 to produce electricity. The working fluid 12 loses pressure in driving the expander 30, and a temperature of the working fluid 12 drops. The working fluid 12 exits the expander 30, and passes through the recuperator 24, and back to the condenser 20.

In some embodiments, the pressure booster 22 and the expander 30 are coupled to a common shaft, such as shaft 32. In some embodiments, the pressure booster 22, the expander 30, and the generator 36 are coupled to a common shaft, such as shaft 32.

The geothermal power system 100 utilizes a geothermal fluid (represented by arrows 102), such as water, steam, brine, a refrigerant, a supercritical fluid, carbon dioxide, ammonia, an organic compound (e.g., a hydrocarbon, a fluorocarbon, etc.), or any combination thereof. In some embodiments, the working fluid 12 in the binary cycle power plant 10 is segregated from the geothermal fluid 102. In some embodiments, the working fluid 12 may include at least a portion of the geothermal fluid 102. In some embodiments, the geothermal fluid 102 may include at least a portion of the working fluid 12.

The geothermal fluid 102 is heated, or is maintained at an elevated temperature, by a subterranean formation 42 below the earth's surface 40. In an example, the temperature of the geothermal fluid 102 is at or about 150 degrees C. or higher, such as 175 degrees C. or higher, 200 degrees C. or higher, 250 degrees C. or higher, or 300 degrees C. or higher. The geothermal fluid 102 is maintained at an elevated pressure in the subterranean formation 42. In an example, the pressure of the geothermal fluid 102 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid.

The geothermal fluid 102 flows from the subterranean formation 42 into a first well 44. In some embodiments, the geothermal fluid 102 flows from the subterranean formation 42 into the first well 44 via one or more fractures 62 in the subterranean formation 42 at the first well 44. In some embodiments, the temperature of the geothermal fluid 102 at a wellhead 45 of the first well 44 is at or near the temperature of the geothermal fluid 102 in the subterranean formation 42.

The geothermal fluid 102 flows from the first well 44 to a pressure exchanger 110. The pressure exchanger 110 may be of any type or combination, such as disclosed in any of Azam Thatte, A New Type of Rotary Liquid Piston Pump for Multi-Phase CO2 Compression, Proceedings of ASME Turbo Expo 2018, GT2018-77011 (Jun. 11-15, 2018, Oslo, Norway); U.S. Pat. No. 5,988,993 titled Pressure Exchanger Having a Rotor With Automatic Axial Alignment, that issued Nov. 23, 1999; or U.S. Pat. No. 10,731,702 titled System and Method for Hybrid Hydrodynamic-Hydrostatic Thrust Bearings, that issued Aug. 4, 2020; all of which are incorporated herein by reference. In some embodiments, the geothermal power system 100 includes a plurality of pressure exchangers 110, such as in a parallel hookup configuration.

The geothermal fluid 102 flows into the pressure exchanger 110 at a first inlet 112, and exits the pressure exchanger 110 at a first outlet 114. The pressure of the geothermal fluid 102 is reduced as the geothermal fluid 102 transits through the pressure exchanger 110 from the first inlet 112 to the first outlet 114 along a first fluid path 116. In an example, the pressure of the geothermal fluid 102 at the first outlet 114 is at or about 20 MPa or less, such as 15 MPa or less, 10 MPa or less, 5 MPa or less, 3 MPa or less, 1 MPa or less, 0.5 MPa or less, or 0.2 MPa or less. The temperature of the geothermal fluid 102 at the first inlet 112 is at or near the temperature of the geothermal fluid 102 at the wellhead 45 of the first well 44. The temperature of the geothermal fluid 102 at the first outlet 114 is at or near the temperature of the geothermal fluid 102 at the first inlet 112.

The geothermal fluid 102 flows from the first outlet 114 of the pressure exchanger 110 to the heat exchanger 26. In some embodiments, the temperature of the geothermal fluid 102 entering the heat exchanger 26 is similar to the temperature of the geothermal fluid 102 at the first well 44. In an example, the geothermal fluid 102 is at or about 150 degrees C. or higher, such as 175 degrees C. or higher, 200 degrees C. or higher, 250 degrees C. or higher, or 300 degrees C. or higher when entering the heat exchanger 26. Heat is transferred from the geothermal fluid 102 to the working fluid 12 as the geothermal fluid 102 flows through the heat exchanger 26. The temperature of the geothermal fluid 102 is lowered to a reduced level as the geothermal fluid 102 flows through the heat exchanger 26. In an example, the temperature of the geothermal fluid 102 upon exiting the heat exchanger 26 is at or about 100 degrees C. or less, such as 90 degrees C. or less, 80 degrees C. or less, 70 degrees C. or less, 60 degrees C. or less, or 50 degrees C. or less.

In some embodiments, the geothermal fluid 102 flows from the heat exchanger 26 to one or more pumps 130. Exemplary pumps 130 include single phase pumps, multi-phase pumps, centrifugal pumps, positive displacement pumps, or the like. In some embodiments, the geothermal fluid 102 flows from the heat exchanger 26 to an intermediate reservoir (such as a pond, a tank, or a subterranean formation different from subterranean formation 42), before flowing to the one or more pumps 130. In some embodiments, the intermediate reservoir is omitted. In some embodiments, the one or more pumps 130 are omitted.

The geothermal fluid 102 flows from the heat exchanger 26 or the intermediate reservoir (if present) via the one or more pumps 130 (if present) to a second inlet 122 of the pressure exchanger 110. In some embodiments, the intermediate reservoir functions as a buffer to facilitate controlling the flow rate of the geothermal fluid 102 from the heat exchanger 26 to the second inlet 122 of the pressure exchanger 110. In an example, the flow rate of the geothermal fluid 102 from the heat exchanger 26 to the second inlet 122 of the pressure exchanger 110 is controlled to smooth out spikes and dips. In another example, the flow rate of the geothermal fluid 102 from the heat exchanger 26 to the second inlet 122 of the pressure exchanger 110 is controlled to correspond to the flow rate of the geothermal fluid 102 from the first outlet 114 of the pressure exchanger 110 to the heat exchanger 26.

The geothermal fluid 102 flows into the pressure exchanger 110 at the second inlet 122, and exits the pressure exchanger 110 at a second outlet 124. The pressure exchanger 110 utilizes the pressure of the relatively hotter geothermal fluid 102 at the first inlet 112 to increase the pressure of the relatively colder geothermal fluid 102 that enters the pressure exchanger 110 at the second inlet 122. The pressure of the geothermal fluid 102 is increased as the geothermal fluid 102 transits through the pressure exchanger 110 from the second inlet 122 to the second outlet 124 along a second fluid path 126. The second fluid path 126 is separate from the first fluid path 116. In an example, the pressure of the geothermal fluid 102 at the second outlet 124 is at or about 3 MPa or higher, such as 5 MPa or higher, 10 MPa or higher, 20 MPa or higher, 30 MPa or higher, 40 MPa or higher, or 50 MPa or higher. In some embodiments, the pressure of the geothermal fluid 102 at the second outlet 124 is less than the pressure of the geothermal fluid 102 at the first inlet 112. In some embodiments, the pressure of the geothermal fluid 102 at the second outlet 124 is substantially equal to the pressure of the geothermal fluid 102 at the first inlet 112. In an example, the pressure of the geothermal fluid 102 at the second outlet 124 is 95% to 100% of the pressure of the geothermal fluid 102 at the first inlet 112. The temperature of the geothermal fluid 102 remains at or near the reduced level as the geothermal fluid 102 transits through the pressure exchanger 110 from the second inlet 122 to the second outlet 124 along the second fluid path 126.

The circuit of routing the geothermal fluid 102 through the pressure exchanger 110, then through the heat exchanger 26, then back through the pressure exchanger 110 provides several benefits. For example, the heat exchanger 26 may be designed to operate at pressures that are lower than the pressure of the geothermal fluid 102 at the wellhead 45, which avoids the expense and inefficiencies of so-called “high pressure heat exchangers” configured to operate at pressures higher than conventional heat exchangers. Additionally, the pressure of the geothermal fluid 102 itself exiting the first well 44 is used to boost the pressure of the geothermal fluid 102 exiting the heat exchanger 26, which avoids the expense and inefficiencies of pumps that operate at pressure ratios (outlet pressure divided by inlet pressure) of ten or more. The pressure of the geothermal fluid 102 at the wellhead 45 is usefully employed, rather than being wasted.

The geothermal fluid 102 flows from the second outlet 124 of the pressure exchanger 110 to one or more turbines 140. In some embodiments, the one or more turbines 140 are Pelton Turbines. In some embodiments, the one or more turbines 140 are other types of turbine, such as Francis Turbines or Kaplan Turbines. In some embodiments, the one or more turbines 140 are located at the earth's surface 40. In some embodiments, the one or more turbines 140 are arranged in a series configuration such that the geothermal fluid 102 flows to a first turbine 140 and then to a second turbine 140. In some embodiments, the one or more turbines 140 are arranged in a parallel configuration. In an example, a first portion of the geothermal fluid 102 flows to a first turbine 140, and a different second portion of the geothermal fluid 102 flows simultaneously to a second turbine 140. In another example, one of the first or second turbines 140 is offline (such as for maintenance), and the geothermal fluid 102 flows to the other of the first or second turbines 140.

Each of the one or more turbines 140 is coupled to a shaft 146. Each shaft 146 is coupled to a corresponding generator 148. In an example, each shaft 146 is coupled to the corresponding generator 148 via a gearbox. Each shaft 146 drives the corresponding generator 148 to produce electricity.

Each of the one or more turbines 140 has an inlet 142 and an outlet 144. The geothermal fluid 102 flows from the inlet 142, and through the turbine 140 to the outlet 144. A pressure of the geothermal fluid 102 at the inlet 142 of each of the one or more turbines 140 is greater than the pressure of the geothermal fluid 102 at the outlet 144 of each of the one or more turbines 140. The geothermal fluid 102 experiences a drop in pressure from the inlet 142 to the outlet 144 of each turbine 140 as the geothermal fluid 102 drives each turbine 140 to rotate the corresponding shaft 146, and drive the corresponding generator 148 to produce electricity. In an example, the pressure of the geothermal fluid 102 at the outlet 144 of each turbine 140 is at or about 1 MPa or less, such as 0.5 MPa or less, 0.4 MPa or less, 0.3 MPa or less, or 0.2 MPa or less.

The geothermal fluid 102 flows from the outlet 144 of each of the one or more turbines 140 to one or more pumps 134. Exemplary pumps 134 include single phase pumps, multi-phase pumps, centrifugal pumps, positive displacement pumps, or the like. The one or more pumps 134 increase a pressure of the geothermal fluid 102, and inject the geothermal fluid 102 into the second well 46. The geothermal fluid 102 flows through the second well 46, and enters the one or more fractures 64 in the subterranean formation 42.

In some embodiments, the geothermal fluid 102 flows from the outlet 144 of each of the one or more turbines 140 to a reservoir 132 (such as a pond, a tank, or a subterranean formation different from subterranean formation 42), before flowing to the one or more pumps 134. In some embodiments, the reservoir 132 provides for temporary storage of the geothermal fluid 102 prior to injecting the geothermal fluid 102 into the second well 46. In an example, the geothermal fluid 102 is utilized in the geothermal power system 100 to produce electricity and is stored in reservoir 132 during a period of relatively high demand for electricity, then is injected into the second well 46 during a subsequent period of relatively low demand for electricity. In some embodiments, the reservoir 132 is omitted.

In some embodiments, the pressure of the geothermal fluid 102 at the wellhead 45 of the first well 44 is maintained at a magnitude such that the one or more fractures 62 remain open while flowing the geothermal fluid 102 to the pressure exchanger 110. In an example, the flow of the geothermal fluid 102 out of the first well 44 is choked by valve 52. In another example, the pressure exchanger 110 is operated such that a back-pressure is exerted on the geothermal fluid 102 at the wellhead 45 of the first well 44.

In some embodiments, the pressure of the geothermal fluid 102 at the wellhead 47 of the second well 46 is maintained at a magnitude such that the one or more fractures 64 remain open. In an example, the one or more pumps 134 are operated to maintain the pressure of the geothermal fluid 102 at the wellhead 47 of the second well 46 at a magnitude such that the one or more fractures 64 remain open.

In some embodiments, the one or more fractures 62 intersect with the one or more fractures 64. In some embodiments, the one or more fractures 62 are contiguous with the one or more fractures 64. In some embodiments, the geothermal fluid 102 flows within the subterranean formation 42 from the second well 46 to the first well 44, and is produced again from the first well 44.

As illustrated, in some embodiments, the geothermal fluid 102 does not flow within the subterranean formation 42 from the second well 46 to the first well 44. In an example, the one or more fractures 62 do not intersect with the one or more fractures 64. In another example, the one or more fractures 62 are not contiguous with the one or more fractures 64. In such embodiments, the geothermal power system 100 is reconfigured to flow the geothermal fluid 102 from the second well 46 to the pressure exchanger 110, and to flow the returning geothermal fluid 102 from the one or more pumps 134 to the first well 44. In an example, the geothermal power system 100 includes a manifold assembly, such as described below.

FIG. 1B schematically illustrates an example manifold assembly 150 that facilitates reconfiguring the geothermal power system 100 to flow the geothermal fluid 102 from the second well 46 to the pressure exchanger 110, and to flow the returning geothermal fluid 102 from the one or more pumps 134 to the first well 44. In some embodiments, geothermal power system 100 incorporates the manifold assembly 150.

The manifold assembly 150 includes a production manifold 160 and an injection manifold 170. Line 162 conveys the geothermal fluid 102 from the production manifold 160 to the pressure exchanger 110. Line 172 conveys the geothermal fluid 102 from the one or more pumps 134 to the injection manifold 170. Line 164 conveys the geothermal fluid 102 from the first well 44 to the production manifold 160. Line 174 conveys the geothermal fluid 102 from the injection manifold 170 to the first well 44. When geothermal fluid 102 is flowing from the first well 44 to the production manifold 160, valve 182 in line 164 is open, and valve 184 in line 174 is closed. When geothermal fluid 102 is flowing from the injection manifold 170 to the first well 44, valve 184 in line 174 is open, and valve 182 in line 164 is closed.

Line 166 conveys the geothermal fluid 102 from the second well 46 to the production manifold 160. Line 176 conveys the geothermal fluid 102 from the injection manifold 170 to the second well 46. When geothermal fluid 102 is flowing from the second well 46 to the production manifold 160, valve 186 in line 166 is open, and valve 188 in line 176 is closed. When geothermal fluid 102 is flowing from the injection manifold 170 to the second well 46, valve 188 in line 176 is open, and valve 186 in line 166 is closed.

In some embodiments, reconfiguring the geothermal power system 100 is prompted by a trigger condition. In an example, the trigger condition includes the flow of geothermal fluid 102 from the first well 44 to the pressure exchanger 110 diminishing to or beyond a threshold level. In another example, the trigger condition includes the pressure of geothermal fluid 102 at the wellhead 45 of the first well 44 diminishing to or beyond a threshold level. In another example, the trigger condition includes the flow of geothermal fluid 102 into the second well 46 diminishing to or beyond a threshold level. In another example, the trigger condition includes the pressure of geothermal fluid 102 at the wellhead 47 of the second well 46 rising to or beyond a threshold level.

When reconfiguring the geothermal power system 100 to flow the geothermal fluid 102 from the second well 46 to the geothermal power system 100, the first well 44 is closed-in, such as by closing the valve 52. In some embodiments, the second well 46 is closed-in, such as by closing valve 54. The manifold assembly 150 is operated such that valve 182 is closed, valve 184 is opened, valve 186 is opened, and valve 188 is closed. Valve 52 is opened to allow geothermal fluid 102 to be injected into the first well 44. If the second well 46 is closed-in, valve 54 is opened to allow geothermal fluid 102 to be produced from the second well 46. The geothermal fluid 102 flows from the subterranean formation 42 via the second well 46 to the pressure exchanger 110, as described above. The returning geothermal fluid 102 flows into the subterranean formation 42 via the first well 44, as described above.

In some embodiments, more than two wells are coupled to the production manifold 160 and to the injection manifold 170. In an example, production of geothermal fluid 102 is started from a third well while the second well 46 remains closed-in. The geothermal fluid 102 flows to the geothermal power system 100 as described above. The geothermal fluid 102 may then be injected into the first well 44 or into a fourth well.

FIG. 1C schematically illustrates an embodiment in which well 70 functions as the first well 44 and the second well 46. In some embodiments, a single well 70 that functions as the first well 44 and the second well 46 is fluidically coupled to the pressure exchanger 110 and to the one or more pumps 134. In some embodiments, the pressure exchanger 110 and the one or more pumps 134 are coupled to a single well 70. In some embodiments, the pressure exchanger 110 and the one or more pumps 134 are coupled to a plurality of wells 70, each of which being configured to function as the first well 44 and the second well 46. In an example, each well 70 is coupled to the production manifold 160 and to the injection manifold 170.

The well 70 includes a production zone 72 and an injection zone 74. Fluids in the subterranean formation 42 flow into the well 70 at the production zone 72. Fluids flow from the well 70 into the subterranean formation 42 at the injection zone 74. A fracture network 60 in the subterranean formation 42 is fluidically coupled to the production zone 72 and to the injection zone 74.

In some embodiments, the well 70 is operated such that the fracture network 60 remains open while the geothermal fluid 102 is produced from the subterranean formation 42 into the production zone 72. In some embodiments, the well 70 is operated such that the fracture network 60 remains open while the geothermal fluid 102 is injected into the subterranean formation 42 at the injection zone 74. In an example, a pressure of the geothermal fluid 102 within the fracture network 60 is maintained at a magnitude that is greater than a closure pressure of one or more fractures of the fracture network 60. In another example, a pressure of the geothermal fluid 102 within the fracture network 60 is maintained at a magnitude that is greater than an opening pressure of one or more fractures of the fracture network 60. In another example, a pressure of the geothermal fluid 102 within the fracture network 60 is maintained at a magnitude that is between the opening pressure and the closure pressure of one or more fractures of the fracture network 60. In another example, a pressure of the geothermal fluid 102 within the fracture network 60 is maintained at a magnitude that is greater than a reopening pressure of one or more fractures of the fracture network 60. In another example, a pressure of the geothermal fluid 102 within the fracture network 60 is maintained at a magnitude that is between the reopening pressure and the closure pressure of one or more fractures of the fracture network 60.

In some embodiments, operation of the well 70 such that the fracture network 60 remains open is performed by regulating a pressure within the well 70 by a control valve, such as valve 52 (FIG. 1A), a choke, or the like. In some embodiments, operation of the well 70 such that fracture network 60 remains open is performed by regulating a pressure within the well 70 by controlling the operation of the pressure exchanger 110. In an example, the pressure drop experienced by the geothermal fluid 102 flowing through the pressure exchanger 110 creates a back-pressure on the geothermal fluid 102 exiting the well 70. In some embodiments, operation of a control valve is omitted when regulating a pressure within the well 70 by controlling the operation of the pressure exchanger 110. In some embodiments, operation of the well 70 such that the fracture network 60 remains open is performed by regulating the one or more pumps 134.

The well 70 includes a tubing string 76 installed inside a casing string 78. A packer 82 seals an annulus 80 between the tubing string 76 and the casing string 78. The packer 82 is located between the production zone 72 and the injection zone 74. The geothermal fluid 102 in the subterranean formation 42 enters the well 70 at the production zone 72, and flows up the tubing string 76 to a wellhead 71. The geothermal fluid 102 flows from the wellhead 71 of the well 70 to the pressure exchanger 110. Operation of the pressure exchanger 110, the heat exchanger 26, the binary cycle power plant 10, the one or more turbines 140 (with associated generators 148), and the one or more pumps 134 is as described above. The one or more pumps 134 inject the geothermal fluid 102 into the annulus 80 of the well 70. The geothermal fluid 102 exits the well 70 at the injection zone 74, and enters the subterranean formation 42.

The geothermal fluid 102 flows in the subterranean formation 42 from the injection zone 74 of the well 70 through the fracture network 60 towards the production zone 72 of the well 70. The geothermal fluid 102 is heated by the subterranean formation 42. In some embodiments, the producing of the geothermal fluid 102 from the subterranean formation 42 via the well 70, and the injecting of the geothermal fluid 102 into the subterranean formation 42 at the well 70 are performed simultaneously.

In some embodiments, the first well 44 and the geothermal power system 100 are operated in a repeating alternating sequence of production of the geothermal fluid 102 from a specific location in the subterranean formation 42, then reinjection of the geothermal fluid 102 into the subterranean formation 42 at the same specific location. Such a sequence may be referred to as “huff and puff.” In an example, the first well 44 is coupled to the geothermal power system 100 via a flowline assembly 190, as schematically illustrated in FIG. 1D.

Line 192 conveys the geothermal fluid 102 from the first well 44 to the pressure exchanger 110. Line 194 conveys the geothermal fluid 102 from the one or more pumps 134 to the first well 44. When geothermal fluid 102 is flowing from the first well 44 to the pressure exchanger 110, valve 196 in line 192 is open, and valve 198 in line 194 is closed. When geothermal fluid 102 is flowing from the one or more pumps 134 to the first well 44, valve 198 in line 194 is open, and valve 196 in line 192 is closed.

The geothermal fluid 102 is produced from the subterranean formation 42 via the first well 44, and flows to the pressure exchanger 110 through line 192. The geothermal fluid 102 is utilized (as described above) in the geothermal power system 100, and then is stored in the reservoir 132. Then the flow of the geothermal fluid 102 from the first well 44 is ceased. Valve 196 of the flowline assembly 190 is closed, and valve 198 of the flowline assembly 190 is opened. Then the one or more pumps 134 pump the geothermal fluid 102 from the reservoir 132 back into the first well 44, and inject the geothermal fluid 102 into the first well 44, and into the subterranean formation 42. Valve 198 of the flowline assembly 190 is closed, and valve 196 of the flowline assembly 190 is opened. Then the sequence is repeated. In some embodiments, a time delay is implemented while the first well 44 is closed-in to allow the geothermal fluid 102 in the subterranean formation 42 (such as in the one or more fractures 62) to become heated by the subterranean formation 42 before reopening the first well 44.

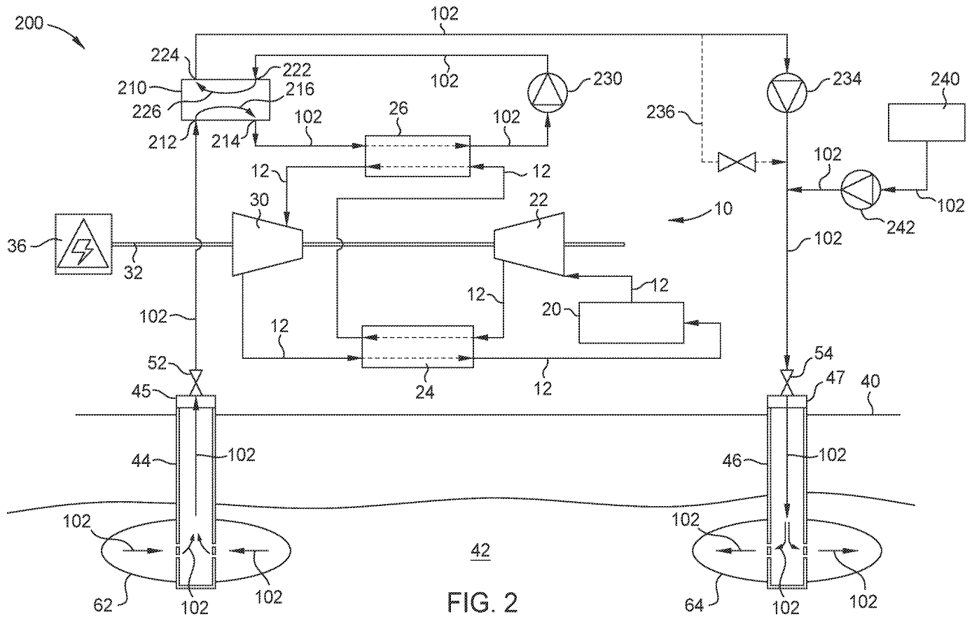

FIG. 2 schematically illustrates a geothermal power system 200. The geothermal power system 200 includes the binary cycle power plant 10, and utilizes the working fluid 12, as described above. The geothermal power system 200 utilizes the geothermal fluid 102 described above. In some embodiments, the working fluid 12 in the binary cycle power plant 10 is segregated from the geothermal fluid 102. In some embodiments, the working fluid 12 may include at least a portion of the geothermal fluid 102. In some embodiments, the geothermal fluid 102 may include at least a portion of the working fluid 12.

The geothermal fluid 102 is heated, or is maintained at an elevated temperature, by the subterranean formation 42. In an example, the temperature of the geothermal fluid 102 is at or about 150 degrees C. or higher, such as 175 degrees C. or higher, 200 degrees C. or higher, 250 degrees C. or higher, or 300 degrees C. or higher. The geothermal fluid 102 is maintained at an elevated pressure in the subterranean formation 42. In an example, the pressure of the geothermal fluid 102 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid.

The geothermal fluid 102 flows from the subterranean formation 42 into the first well 44. In some embodiments, the geothermal fluid 102 flows from the subterranean formation 42 into the first well 44 via one or more fractures 62 in the subterranean formation 42 at the first well 44. In some embodiments, the temperature of the geothermal fluid 102 at the wellhead 45 of the first well 44 is at or near the temperature of the geothermal fluid 102 in the subterranean formation 42.

The geothermal fluid 102 flows from the first well 44 to a pressure exchanger 210. The pressure exchanger 210 may be of any type or combination, such as disclosed in any of Azam Thatte, A New Type of Rotary Liquid Piston Pump for Multi-Phase CO2 Compression, Proceedings of ASME Turbo Expo 2018, GT2018-77011 (Jun. 11-15, 2018, Oslo, Norway); U.S. Pat. No. 5,988,993 titled Pressure Exchanger Having a Rotor With Automatic Axial Alignment, that issued Nov. 23, 1999; or U.S. Pat. No. 10,731,702 titled System and Method for Hybrid Hydrodynamic-Hydrostatic Thrust Bearings, that issued Aug. 4, 2020; all of which are incorporated herein by reference. In some embodiments, the geothermal power system 200 includes a plurality of pressure exchangers 210, such as in a parallel hookup configuration.

The geothermal fluid 102 flows into the pressure exchanger 210 at a first inlet 212, and exits the pressure exchanger 210 at a first outlet 214. The pressure of the geothermal fluid 102 is reduced as the geothermal fluid 102 transits through the pressure exchanger 210 from the first inlet 212 to the first outlet 214 along a first fluid path 216. In an example, the pressure of the geothermal fluid 102 at the first outlet 214 is at or about 20 MPa or less, such as 15 MPa or less, 10 MPa or less, 5 MPa or less, 3 MPa or less, 1 MPa or less, 0.5 MPa or less, or 0.2 MPa or less. The temperature of the geothermal fluid 102 at the first inlet 212 is at or near the temperature of the geothermal fluid 102 at the wellhead 45 of the first well 44. The temperature of the geothermal fluid 102 at the first outlet 214 is at or near the temperature of the geothermal fluid 102 at the first inlet 212.

The geothermal fluid 102 flows from the first outlet 214 of the pressure exchanger 210 to the heat exchanger 26. In some embodiments, the temperature of the geothermal fluid 102 entering the heat exchanger 26 is similar to the temperature of the geothermal fluid 102 at the first well 44. In an example, the geothermal fluid 102 is at or about 150 degrees C. or higher, such as 175 degrees C. or higher, 200 degrees C. or higher, 250 degrees C. or higher, or 300 degrees C. or higher when entering the heat exchanger 26. Heat is transferred from the geothermal fluid 102 to the working fluid 12 as the geothermal fluid 102 flows through the heat exchanger 26. The temperature of the geothermal fluid 102 is lowered to a reduced level as the geothermal fluid 102 flows through the heat exchanger 26. In an example, the temperature of the geothermal fluid 102 upon exiting the heat exchanger 26 is at or about 100 degrees C. or less, such as 90 degrees C. or less, 80 degrees C. or less, 70 degrees C. or less, 60 degrees C. or less, or 50 degrees C. or less.

In some embodiments, the geothermal fluid 102 flows from the heat exchanger 26 to one or more pumps 230. Exemplary pumps 230 include single phase pumps, multi-phase pumps, centrifugal pumps, positive displacement pumps, or the like. In some embodiments, the geothermal fluid 102 flows from the heat exchanger 26 to an intermediate reservoir (such as a pond, a tank, or a subterranean formation different from subterranean formation 42), before flowing to the one or more pumps 230. In some embodiments, the intermediate reservoir is omitted. In some embodiments, the one or more pumps 230 are omitted.

The geothermal fluid 102 flows from the heat exchanger 26 or the intermediate reservoir (if present) via the one or more pumps 230 (if present) to a second inlet 222 of the pressure exchanger 210. In some embodiments, the intermediate reservoir functions as a buffer to facilitate controlling the flow rate of the geothermal fluid 102 from the heat exchanger 26 to the second inlet 222 of the pressure exchanger 210. In an example, the flow rate of the geothermal fluid 102 from the heat exchanger 26 to the second inlet 222 of the pressure exchanger 210 is controlled to smooth out spikes and dips. In another example, the flow rate of the geothermal fluid 102 from the heat exchanger 26 to the second inlet 222 of the pressure exchanger 210 is controlled to correspond to the flow rate of the geothermal fluid 102 from the first outlet 214 of the pressure exchanger 210 to the heat exchanger 26.

The geothermal fluid 102 flows into the pressure exchanger 210 at the second inlet 222, and exits the pressure exchanger 210 at a second outlet 224. The pressure exchanger 210 utilizes the pressure of the relatively hotter geothermal fluid 102 at the first inlet 212 to increase the pressure of the relatively colder geothermal fluid 102 that enters the pressure exchanger 210 at the second inlet 222. The pressure of the geothermal fluid 102 is increased as the geothermal fluid 102 transits through the pressure exchanger 210 from the second inlet 222 to the second outlet 224 along a second fluid path 226. The second fluid path 226 is separate from the first fluid path 216. In an example, the pressure of the geothermal fluid 102 at the second outlet 224 is at or about 3 MPa or higher, such as 5 MPa or higher, 10 MPa or higher, 20 MPa or higher, 30 MPa or higher, 40 MPa or higher, or 50 MPa or higher. In some embodiments, the pressure of the geothermal fluid 102 at the second outlet 224 is less than the pressure of the geothermal fluid 102 at the first inlet 212. In some embodiments, the pressure of the geothermal fluid 102 at the second outlet 224 is substantially equal to the pressure of the geothermal fluid 102 at the first inlet 212. In an example, the pressure of the geothermal fluid 102 at the second outlet 224 is 95% to 100% of the pressure of the geothermal fluid 102 at the first inlet 212. The temperature of the geothermal fluid 102 remains at or near the reduced level as the geothermal fluid 102 transits through the pressure exchanger 210 from the second inlet 222 to the second outlet 224 along the second fluid path 226.

The circuit of routing the geothermal fluid 102 through the pressure exchanger 210, then through the heat exchanger 26, then back through the pressure exchanger 210 provides several benefits. For example, the heat exchanger 26 may be designed to operate at pressures that are lower than the pressure of the geothermal fluid 102 at the wellhead 45, which avoids the expense and inefficiencies of so-called “high pressure heat exchangers” configured to operate at pressures higher than conventional heat exchangers. Additionally, the pressure of the geothermal fluid 102 itself exiting the first well 44 is used to boost the pressure of the geothermal fluid 102 exiting the heat exchanger 26, which avoids the expense and inefficiencies of pumps that operate at pressure ratios (outlet pressure divided by inlet pressure) of ten or more. The pressure of the geothermal fluid 102 at the wellhead 45 is usefully employed, rather than being wasted.

In some embodiments, the geothermal fluid 102 flows from the pressure exchanger 210 to one or more pumps 234. Exemplary pumps 234 include single phase pumps, multi-phase pumps, centrifugal pumps, positive displacement pumps, or the like. The one or more pumps 234 increase a pressure of the geothermal fluid 102, and inject the geothermal fluid 102 into the second well 46. In some embodiments, the one or more pumps 234 are booster pumps. In an example, the pressure increase provided by the one or more pumps 234 is less than an inlet pressure of the one or more pumps 234. In some embodiments, the one or more pumps 234 are operated at an efficiency of 90% or above, such as 92% or above, or 95% or above.

In some embodiments, the pressure of the geothermal fluid 102 at the second outlet 224 of the pressure exchanger 210 is greater than the pressure of the geothermal fluid 102 at the wellhead 47 of the second well 46. In some of such embodiments, the geothermal fluid 102 flows through a bypass 236 of the one or more pumps 234 when flowing from the pressure exchanger 210 to the second well 46. As flow of the geothermal fluid 102 continues, the pressure at the wellhead 47 of the second well 46 increases. The pressure at the second outlet 224 of the pressure exchanger 210 and the pressure at the wellhead 47 of the second well 46 approach an equilibrium. Prior to, or upon, the pressures at the second outlet 224 of the pressure exchanger 210 and at the wellhead 47 reaching an equilibrium, the geothermal fluid 102 is routed to the one or more pumps 234, which pump the geothermal fluid 102 into the second well 46.

In some embodiments, additional geothermal fluid 102 is injected into the second well 46 from a reservoir 240 (such as a pond, a tank, or a subterranean formation different from subterranean formation 42), using one or more charge pumps 242. Exemplary charge pumps 242 include single phase pumps, multi-phase pumps, centrifugal pumps, positive displacement pumps, or the like. In some embodiments, the additional geothermal fluid 102 is a make-up fluid that compensates for losses of geothermal fluid 102 into the subterranean formation 42. In some embodiments, the one or more charge pumps 242 pump geothermal fluid 102 from the reservoir 240 into the second well 46 to establish a selected operating pressure at the wellhead 47 of the second well 46. The operating pressure at the wellhead 47 of the second well 46 may be selected such that the one or more fractures 64 in the subterranean formation 42 are open.

In some embodiments, the one or more charge pumps 242 are fluidically coupled to the wellhead 47 via the flowline from the one or more pumps 234 (or the bypass 236) to the wellhead 47. In some embodiments, the one or more charge pumps 242 are fluidically coupled directly to the wellhead 47 via a separate flowline.

In some embodiments, the one or more charge pumps 242 are operated intermittently to pump geothermal fluid 102 from the reservoir 240 and into the second well 46 while geothermal fluid 102 flows from the pressure exchanger 210 to the second well 46. In some embodiments, the one or more charge pumps 242 are operated continuously to pump geothermal fluid 102 from the reservoir 240 and into the second well 46 while geothermal fluid 102 flows from the pressure exchanger 210 to the second well 46. In some embodiments, the reservoir 240 and the one or more charge pumps 242 may be omitted.

In some embodiments, the pressure of the geothermal fluid 102 at the wellhead 45 of the first well 44 is maintained at a magnitude such that the one or more fractures 62 remain open while flowing the geothermal fluid 102 to the pressure exchanger 210. In an example, the flow of the geothermal fluid 102 out of the first well 44 is choked by the valve 52. In another example, the pressure exchanger 210 is operated such that a back-pressure is exerted on the geothermal fluid 102 at the wellhead 45 of the first well 44.

In some embodiments, the pressure of the geothermal fluid 102 at the wellhead 47 of the second well 46 is maintained at a magnitude such that the one or more fractures 64 remain open. In an example, the one or more pumps 234 are operated to maintain the pressure of the geothermal fluid 102 at the wellhead 47 of the second well 46 at a magnitude such that the one or more fractures 64 remain open. In another example, the pressure exchanger 210 is operated such that the pressure of the geothermal fluid 102 exiting the pressure exchanger 210 at the second outlet 224 is at a magnitude such that the pressure of the geothermal fluid 102 at the wellhead 47 of the second well 46 is sufficient to maintain the one or more fractures 64 open. In a further example, the one or more charge pumps 242 (if present) are operated such that the pressure of the geothermal fluid 102 at the wellhead 47 of the second well 46 is sufficient to maintain the one or more fractures 64 open.

In some embodiments, the one or more fractures 62 intersect with the one or more fractures 64. In some embodiments, the one or more fractures 62 are contiguous with the one or more fractures 64. In some embodiments, the geothermal fluid 102 flows within the subterranean formation 42 from the second well 46 to the first well 44, and is produced again from the first well 44.

As illustrated, in some embodiments, the geothermal fluid 102 does not flow within the subterranean formation 42 from the second well 46 to the first well 44. In an example, the one or more fractures 62 do not intersect with the one or more fractures 64. In another example, the one or more fractures 62 are not contiguous with the one or more fractures 64. In such embodiments, the geothermal power system 200 is reconfigured to flow the geothermal fluid 102 from the second well 46 to the pressure exchanger 210, and to flow the returning geothermal fluid 102 from the one or more pumps 234 to the first well 44. In an example, the geothermal power system 200 includes the manifold assembly 150, described above.

When the geothermal power system 200 includes the manifold assembly 150, line 162 fluidically couples the production manifold 160 with the pressure exchanger 210. When the geothermal power system 200 includes the manifold assembly 150, line 172 fluidically couples the one or more pumps 234 (or the bypass 236) to the injection manifold 170. In some embodiments, when the geothermal power system 200 includes the manifold assembly 150, line 172 fluidically couples the one or more charge pumps 242 to the injection manifold 170. In some embodiments, when the geothermal power system 200 includes the manifold assembly 150, an additional line fluidically couples the one or more charge pumps 242 to the injection manifold 170. The manifold assembly 150, first well 44, second well 46, third well (if present), and fourth well (if present) are operated as described above.

Additionally, or alternatively, the geothermal power system 200 is coupled to the well 70, as described above. In such embodiments, the well 70 is operated as described above when coupled to the geothermal power system 200. The geothermal fluid 102 produced from the subterranean formation 42 at the production zone 72 flows up the tubing string 76 to the wellhead 71, and from the wellhead 71 to the pressure exchanger 210. The geothermal fluid 102 flows from the one or more pumps 234 or the bypass 236 into the annulus 80, and into the subterranean formation 42 at the injection zone 74. In some embodiments, the one or more charge pumps 242 pump additional geothermal fluid 102 from the reservoir 240 into the annulus 80, and into the subterranean formation 42 at the injection zone 74.

Additionally, or alternatively, the first well 44 is coupled to the geothermal power system 200 via the flowline assembly 190, described above. In such embodiments, the first well 44 is operated as described above when coupled to the geothermal power system 200 via the flowline assembly 190. The geothermal fluid 102 produced from the subterranean formation 42 via the first well 44 flows through line 192 to the pressure exchanger 210. The geothermal fluid 102 flows from the one or more pumps 234 or the bypass 236 through line 194 back to the first well 44, and is reinjected into the subterranean formation 42. In some embodiments, the one or more charge pumps 242 pump additional geothermal fluid 102 from the reservoir 240 through line 194 to the first well 44, and inject the additional geothermal fluid 102 into the subterranean formation 42.

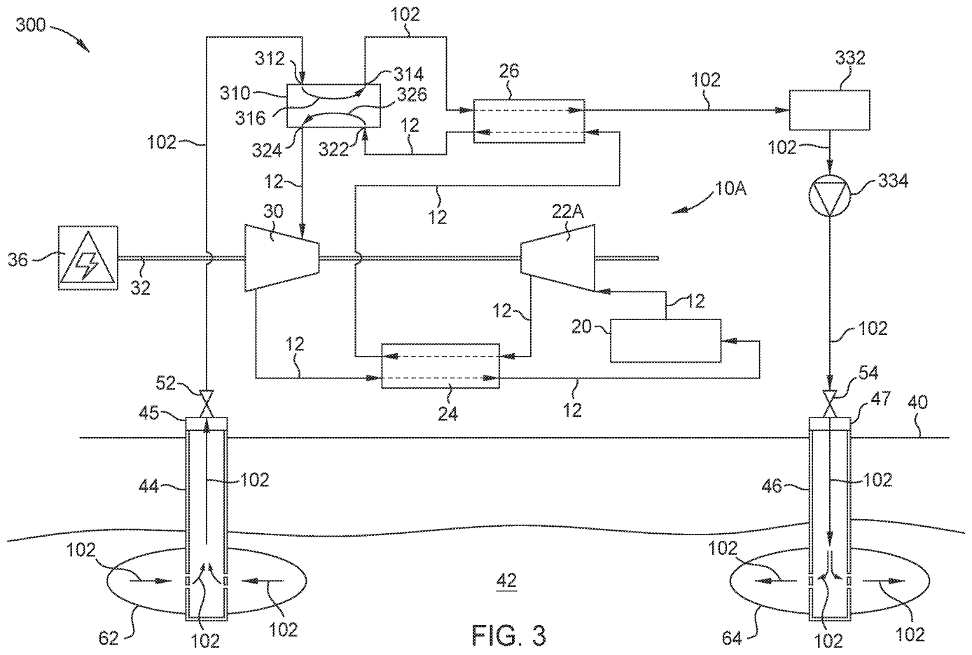

FIG. 3 schematically illustrates a geothermal power system 300. The geothermal power system 300 includes a binary cycle power plant 10A that utilizes the working fluid 12, as described above. Binary cycle power plant 10A is similar to binary cycle power plant 10 described above, except that after passing through the heat exchanger 26, the working fluid 12 passes through a pressure exchanger 310 before entering the expander 30.

The geothermal power system 300 utilizes the geothermal fluid 102 described above. In some embodiments, the working fluid 12 in the binary cycle power plant 10 is segregated from the geothermal fluid 102. In some embodiments, the working fluid 12 may include at least a portion of the geothermal fluid 102. In some embodiments, the geothermal fluid 102 may include at least a portion of the working fluid 12.

The geothermal fluid 102 is heated, or is maintained at an elevated temperature, by the subterranean formation 42. In an example, the temperature of the geothermal fluid 102 is at or about 150 degrees C. or higher, such as 175 degrees C. or higher, 200 degrees C. or higher, 250 degrees C. or higher, or 300 degrees C. or higher. The geothermal fluid 102 is maintained at an elevated pressure in the subterranean formation 42. In an example, the pressure of the geothermal fluid 102 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the geothermal fluid 102 is geopressured. In an example, the geothermal fluid 102 may be a geopressured-geothermal fluid.

The geothermal fluid 102 flows from the subterranean formation 42 into the first well 44. In some embodiments, the geothermal fluid 102 flows from the subterranean formation 42 into the first well 44 via one or more fractures 62 in the subterranean formation 42 at the first well 44. In some embodiments, the temperature of the geothermal fluid 102 at the wellhead 45 of the first well 44 is at or near the temperature of the geothermal fluid 102 in the subterranean formation 42.

The geothermal fluid 102 flows from the first well 44 to a pressure exchanger 310. The pressure exchanger 310 may be of any type or combination, such as disclosed in any of Azam Thatte, A New Type of Rotary Liquid Piston Pump for Multi-Phase CO2 Compression, Proceedings of ASME Turbo Expo 2018, GT2018-77011 (Jun. 11-15, 2018, Oslo, Norway); U.S. Pat. No. 5,988,993 titled Pressure Exchanger Having a Rotor With Automatic Axial Alignment, that issued Nov. 23, 1999; or U.S. Pat. No. 10,731,702 titled System and Method for Hybrid Hydrodynamic-Hydrostatic Thrust Bearings, that issued Aug. 4, 2020; all of which are incorporated herein by reference. In some embodiments, the geothermal power system 300 includes a plurality of pressure exchangers 310, such as in a parallel hookup configuration.

The geothermal fluid 102 flows into the pressure exchanger 310 at a first inlet 312, and exits the pressure exchanger 310 at a first outlet 314. The pressure of the geothermal fluid 102 is reduced as the geothermal fluid 102 transits through the pressure exchanger 310 from the first inlet 312 to the first outlet 314 along a first fluid path 316. In an example, the pressure of the geothermal fluid 102 at the first outlet 314 is at or about 20 MPa or less, such as 15 MPa or less, 10 MPa or less, 5 MPa or less, 3 MPa or less, 1 MPa or less, 0.5 MPa or less, or 0.2 MPa or less. The temperature of the geothermal fluid 102 at the first inlet 312 is at or near the temperature of the geothermal fluid 102 at the wellhead 45 of the first well 44. The temperature of the geothermal fluid 102 at the first outlet 314 is at or near the temperature of the geothermal fluid 102 at the first inlet 312.

The geothermal fluid 102 flows from the first outlet 314 of the pressure exchanger 310 to the heat exchanger 26. In some embodiments, the temperature of the geothermal fluid 102 entering the heat exchanger 26 is similar to the temperature of the geothermal fluid 102 at the first outlet 314, such as at or near the temperature of the geothermal fluid 102 at the first inlet 312 or at the first well 44. In an example, the geothermal fluid 102 is at or about 150 degrees C. or higher, such as 175 degrees C. or higher, 200 degrees C. or higher, 250 degrees C. or higher, or 300 degrees C. or higher when entering the heat exchanger 26.

Heat is transferred from the geothermal fluid 102 to the working fluid 12 as the geothermal fluid 102 flows through the heat exchanger 26. The temperature of the geothermal fluid 102 is lowered to a reduced level as the geothermal fluid 102 flows through the heat exchanger 26. In an example, the temperature of the geothermal fluid 102 upon exiting the heat exchanger 26 is at or about 100 degrees C. or less, such as 90 degrees C. or less, 80 degrees C. or less, 70 degrees C. or less, 60 degrees C. or less, or 50 degrees C. or less. In an example, at the heat exchanger 26, the temperature of the working fluid 12 is increased to 100 degrees C. or higher, such as 125 degrees C. or higher, 150 degrees C. or higher, 175 degrees C. or higher, or 200 degrees C. or higher.

The geothermal fluid 102 flows through the pressure exchanger 310 and then through the heat exchanger 26. The working fluid 12 flows in the opposite direction to the geothermal fluid 102. The working fluid 12 flows through the heat exchanger 26 and then through the pressure exchanger 310.

The working fluid 12 flows into the pressure exchanger 310 at a second inlet 322, and exits the pressure exchanger 310 at a second outlet 324. The pressure exchanger 310 utilizes the pressure of the geothermal fluid 102 at the first inlet 212 to increase the pressure of the working fluid 12. The pressure of the working fluid 12 is increased as the working fluid 12 transits through the pressure exchanger 310 from the second inlet 322 to the second outlet 324 along a second fluid path 326. The second fluid path 326 is separate from the first fluid path 316. In an example, the pressure of the working fluid 12 at the second outlet 324 is at or about 5 MPa or higher, such as 7.5 MPa or higher, 10 MPa or higher, 12.5 MPa or higher, or 15 MPa or higher.

The transfer of heat energy from the geothermal fluid 102 to the working fluid 12 occurs while both the geothermal fluid 102 and the working fluid 12 are at relatively low pressures compared to the pressures of the geothermal fluid 102 and the working fluid 12 at one or more other stages of the geothermal power plant 300. For example, the pressure of the geothermal fluid 102 at the heat exchanger 26 is lower than the pressure of the geothermal fluid 102 at the first inlet 312 of the pressure exchanger 310. Additionally, the pressure of the working fluid 12 at the heat exchanger 26 is lower than the pressure of the working fluid 12 at the second outlet 324 of the pressure exchanger 310.

The transfer of pressure energy from the geothermal fluid 102 to the working fluid 12 occurs while both the geothermal fluid 102 and the working fluid 12 are at relatively high temperatures compared to the temperatures of the geothermal fluid 102 and the working fluid 12 at one or more other stages of the geothermal power plant 300. For example, the temperature of the geothermal fluid 102 at the pressure exchanger 310 is greater than the temperature of the geothermal fluid 102 exiting the heat exchanger 26. Additionally, the temperature of the working fluid 12 at the pressure exchanger 310 is greater than the temperature of the working fluid 12 entering the heat exchanger 26.

In some embodiments, the temperature of the working fluid 12 at the second outlet 324 is at or near the temperature of the working fluid 12 at the second inlet 322 of the pressure exchanger 310. In some embodiments, the temperature of the working fluid 12 at the second outlet 324 is at or near the temperature of the working fluid 12 exiting the heat exchanger 26.

The working fluid 12 flows from the pressure exchanger 310 to the expander 30. The working fluid 12 loses heat and pressure as the working fluid 12 drives the expander 30 and the associated generator 36 to generate electricity. For example, the pressure of the working fluid 12 exiting the expander 30 may be at or about 5 MPa or lower, such as 4 MPa or lower, 3 MPa or lower, 2 MPa or lower, 1 MPa or lower, or 0.5 MPa or lower. Additionally, the temperature of the working fluid 12 exiting the expander 30 may be at or about 100 degrees C. or less, such as 90 degrees C. or less, 80 degrees C. or less, 70 degrees C. or less, 60 degrees C. or less, or 50 degrees C. or less.

The working fluid 12 flows from the expander 30 through the recuperator 24 and the condenser 20, as described above. The working fluid 12 flows from the condenser 20 to a pressure booster, such as pressure booster 22 (FIG. 1A). In some embodiments, in binary cycle power plant 10A, the pressure booster 22 is replaced by pressure booster 22A. The pressure booster 22A, such as a pump (e.g. a single phase pump, a multi-phase pump, a centrifugal pump, or a positive displacement pump), a compressor, or the like. The pressure booster 22A may be sized to provide a smaller pressure boost to the working fluid 12 than would be provided by the pressure booster 22.

The pressure booster 22A increases the pressure of the working fluid 12, and moves the working fluid 12 through the recuperator 24 to the heat exchanger 26, where the working fluid 12 is heated, as described above. In some embodiments, the pressure exchanger 310 provides a majority of the boost in pressure to the working fluid 12 after the working fluid 12 exits the condenser 20 prior to entering the expander 30. In some embodiments, the pressure booster 22A provides a majority of the boost in pressure to the working fluid 12 after the working fluid 12 exits the condenser 20 prior to entering the expander 30. In some embodiments, the pressure exchanger 310 and the pressure booster 22A provide a substantially equal amount of the boost in pressure to the working fluid 12 after the working fluid 12 exits the condenser 20 prior to entering the expander 30.

As described above, the geothermal power system 300 transfers heat energy and pressure energy of the geothermal fluid 102 to the working fluid 12 of the binary cycle power plant 10A. The binary cycle power plant 10A converts the transferred heat energy and pressure energy into electricity.

Turning back to the flow of the geothermal fluid 102, the geothermal fluid 102 flows from the heat exchanger 26 to one or more pumps 334. Exemplary pumps 334 include single phase pumps, multi-phase pumps, centrifugal pumps, positive displacement pumps, or the like. The one or more pumps 334 increase a pressure of the geothermal fluid 102, and inject the geothermal fluid 102 into the second well 46. The geothermal fluid 102 flows through the second well 46, and enters the one or more fractures 64 in the subterranean formation 42.

In some embodiments, the geothermal fluid 102 flows from the heat exchanger 26 to a reservoir 332 (such as a pond, a tank, or a subterranean formation different from subterranean formation 42), before flowing to the one or more pumps 334. In some embodiments, the reservoir 332 provides for temporary storage of the geothermal fluid 102 prior to injecting the geothermal fluid 102 into the second well 46. In an example, the geothermal fluid 102 is utilized in the geothermal power system 300 to produce electricity and is stored in reservoir 332 during a period of relatively high demand for electricity, then is injected into the second well 46 during a subsequent period of relatively low demand for electricity. In some embodiments, the reservoir 332 is omitted.

In some embodiments, the pressure of the geothermal fluid 102 at the wellhead 45 of the first well 44 is maintained at a magnitude such that the one or more fractures 62 remain open while flowing the geothermal fluid 102 to the pressure exchanger 310. In an example, the flow of the geothermal fluid 102 out of the first well 44 is choked by valve 52. In another example, the pressure exchanger 310 is operated such that a back-pressure is exerted on the geothermal fluid 102 at the wellhead 45 of the first well 44.

In some embodiments, the pressure of the geothermal fluid 102 at the wellhead 47 of the second well 46 is maintained at a magnitude such that the one or more fractures 64 remain open. In an example, the one or more pumps 334 are operated to maintain the pressure of the geothermal fluid 102 at the wellhead 47 of the second well 46 at a magnitude such that the one or more fractures 64 remain open.

In some embodiments, the one or more fractures 62 intersect with the one or more fractures 64. In some embodiments, the one or more fractures 62 are contiguous with the one or more fractures 64. In some embodiments, the geothermal fluid 102 flows within the subterranean formation 42 from the second well 46 to the first well 44, and is produced again from the first well 44.

As illustrated, in some embodiments, the geothermal fluid 102 does not flow within the subterranean formation 42 from the second well 46 to the first well 44. In an example, the one or more fractures 62 do not intersect with the one or more fractures 64. In another example, the one or more fractures 62 are not contiguous with the one or more fractures 64. In such embodiments, the geothermal power system 300 is reconfigured to flow the geothermal fluid 102 from the second well 46 to the pressure exchanger 310, and to flow the returning geothermal fluid 102 from the one or more pumps 334 to the first well 44. In an example, the geothermal power system 300 includes the manifold assembly 150, described above.

When the geothermal power system 300 includes the manifold assembly 150, line 162 fluidically couples the production manifold 160 with the pressure exchanger 310. When the geothermal power system 300 includes the manifold assembly 150, line 172 fluidically couples the one or more pumps 334 to the injection manifold 170. The manifold assembly 150, first well 44, second well 46, third well (if present), and fourth well (if present) are operated as described above.

Additionally, or alternatively, the geothermal power system 300 is coupled to the well 70, as described above. In such embodiments, the well 70 is operated as described above when coupled to the geothermal power system 300. The geothermal fluid 102 produced from the subterranean formation 42 at the production zone 72 flows up the tubing string 76 to the wellhead 71, and from the wellhead 71 to the pressure exchanger 310. The geothermal fluid 102 flows from the one or more pumps 334 into the annulus 80, and into the subterranean formation 42 at the injection zone 74.

Additionally, or alternatively, the first well 44 is coupled to the geothermal power system 300 via the flowline assembly 190, described above. In such embodiments, the first well 44 is operated as described above when coupled to the geothermal power system 300 via the flowline assembly 190. The geothermal fluid 102 produced from the subterranean formation 42 via the first well 44 flows through line 192 to the pressure exchanger 310. The geothermal fluid 102 flows from the one or more pumps 334 through line 194 back to the first well 44, and is reinjected into the subterranean formation 42.

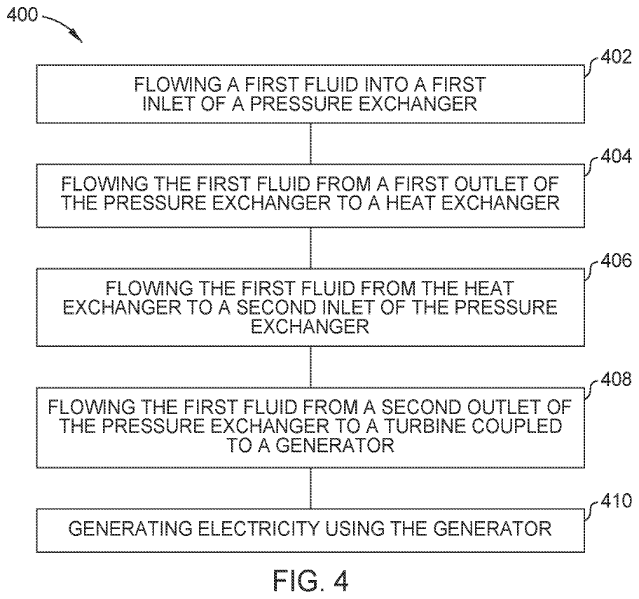

FIG. 4 is a flow diagram of a method 400 of operating a geothermal power system, such as geothermal power system 100.

Operation 402 includes flowing a first fluid into a first inlet of a pressure exchanger. In some embodiments, the first fluid is a geothermal fluid, such as geothermal fluid 102. In some embodiments, the first fluid is produced from a subterranean formation, such as subterranean formation 42. In some embodiments, the pressure exchanger is pressure exchanger 110.

Operation 404 includes flowing the first fluid from a first outlet of the pressure exchanger to a heat exchanger. In some embodiments, method 400 includes reducing a pressure of the first fluid in the pressure exchanger as the first fluid transits from the first inlet to the first outlet. In some embodiments, the heat exchanger is heat exchanger 26. In some embodiments, method 400 includes using heat of the first fluid to increase a temperature of a second fluid at the heat exchanger. In some embodiments, the second fluid is a working fluid, such as working fluid 12. In some embodiments, method 400 includes flowing the second fluid through an expander coupled to a generator, and generating electricity using the generator.

Operation 406 includes flowing the first fluid from the heat exchanger to a second inlet of the pressure exchanger. In some embodiments, operation 406 includes pumping the first fluid from the heat exchanger to the second inlet of the pressure exchanger.

Operation 408 includes flowing the first fluid from a second outlet of the pressure exchanger to a turbine coupled to a generator. In some embodiments, the turbine is one of the one or more turbines 140. In some embodiments, the generator is generator 148.

In some embodiments, method 400 includes increasing a pressure of the first fluid in the pressure exchanger as the first fluid transits from the second inlet to the second outlet. In some embodiments, the first fluid transits from the first inlet of the pressure exchanger to the first outlet of the first pressure exchanger in a first fluid path, and transits from the second inlet of the pressure exchanger to the second outlet of the pressure exchanger in a second fluid path separate from the first fluid path.

Operation 410 includes generating electricity using the generator.

In some embodiments, method 400 includes producing the first fluid from a subterranean formation into a well, and flowing the first fluid from the well to the pressure exchanger. In some embodiments, method 400 includes flowing the first fluid from the turbine to a reservoir, such as reservoir 132. In some embodiments, method 400 includes pumping the first fluid from the reservoir back into the subterranean formation at the well. In some embodiments, the well is configured similarly to first well 44. In some embodiments, the well is configured similarly to well 70.

In some embodiments, method 400 includes producing the first fluid from a subterranean formation into a first well (such as first well 44), and flowing the first fluid from the well to the pressure exchanger. In some embodiments, method 400 includes flowing the first fluid from the turbine to a second well (such as second well 46). In some embodiments, method 400 includes injecting the first fluid into the subterranean formation at the second well.

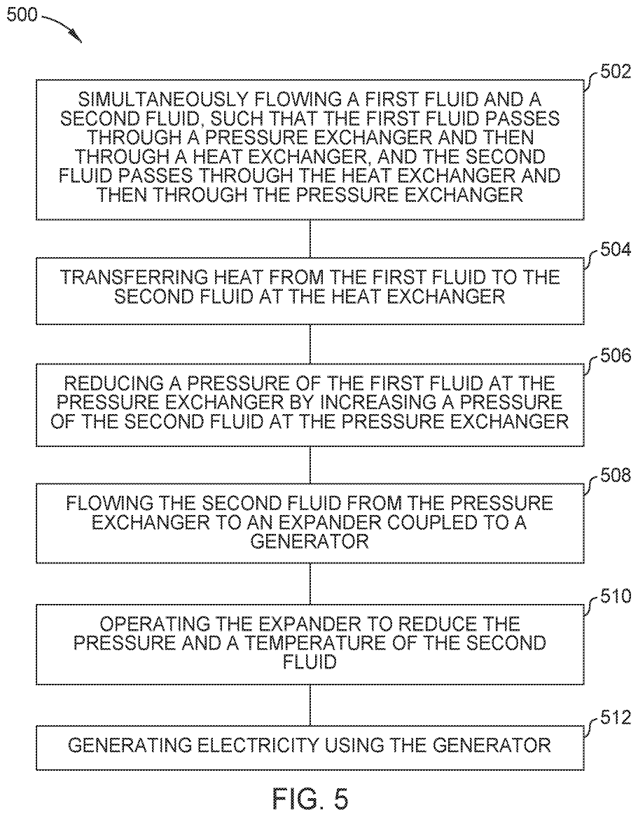

FIG. 5 is a flow diagram of a method 500 of operating a geothermal power system, such as geothermal power system 300.

Operation 502 includes simultaneously flowing a first fluid and a second fluid, such that the first fluid passes through a pressure exchanger and then through a heat exchanger, and the second fluid passes through the heat exchanger and then through the pressure exchanger. In some embodiments, the pressure exchanger is pressure exchanger 310. In some embodiments, the heat exchanger is heat exchanger 26.

In some embodiments, the first fluid is a geothermal fluid, such as geothermal fluid 102. In some embodiments, the first fluid is produced from a subterranean formation, such as subterranean formation 42. In some embodiments, the second fluid is a working fluid, such as working fluid 12.

Operation 504 includes transferring heat from the first fluid to the second fluid at the heat exchanger.

Operation 506 includes reducing a pressure of the first fluid at the pressure exchanger by increasing a pressure of the second fluid at the pressure exchanger. In some embodiments, the first fluid transits from a first inlet of the pressure exchanger to a first outlet of the pressure exchanger in a first fluid path, and the second fluid transits from a second inlet of the pressure exchanger to a second outlet of the pressure exchanger in a second fluid path separate from the first fluid path.

Operation 508 includes flowing the second fluid from the pressure exchanger to an expander (such as expander 30) coupled to a generator (such as generator 36). Operation 510 includes operating the expander to reduce the pressure and a temperature of the second fluid. Operation 512 includes generating electricity using the generator.

In some embodiments, method 500 includes producing the first fluid from a subterranean formation into a well (such as first well 44 or well 70), and flowing the first fluid from the well to the pressure exchanger. In some embodiments, method 500 includes pumping the first fluid into the well, and injecting the first fluid back into the subterranean formation. In some embodiments, method 500 includes flowing the first fluid from the pressure exchanger to a reservoir (such as reservoir 332) prior to pumping the first fluid into the well. In some embodiments, method 500 includes ceasing production of the first fluid from the well prior to pumping the first fluid into the well.

In some embodiments, producing the first fluid from the subterranean formation comprises producing the first fluid from the subterranean formation at a first zone of the well, and injecting the first fluid back into the subterranean formation comprises injecting the first fluid into the subterranean formation at a second zone of the well, the second zone different from the first zone.

In some embodiments, method 500 includes producing the first fluid from a subterranean formation into a first well (such as first well 44), flowing the first fluid from the first well to the pressure exchanger, and injecting the first fluid back into the subterranean formation via a second well (such as second well 46).

It is contemplated that method 400 may include any one or more of the operations or activities described herein. It is contemplated that method 500 may include any one or more of the operations or activities described herein. For example, method 400 or method 500 may include injecting additional geothermal fluid into the second well, the additional geothermal fluid being sourced from a reservoir (such as reservoir 240). Method 400 or method 500 may include injecting the additional geothermal fluid into the second well using a charge pump (such as charge pump 242). Method 400 or method 500 may include injecting the additional geothermal fluid into the second well using the charge pump to establish a selected operating pressure at a wellhead of the second well. The operating pressure at the wellhead of the second well may be selected such that one or more fractures in the subterranean formation coupled to the second well are open.

Aspects of the present disclosure present systems and methods for generating electricity using a geothermal fluid. In some aspects, pressure energy of the geothermal fluid is converted into electricity. In some aspects, heat energy of the geothermal fluid is converted into electricity. In some aspects, a pressure of the geothermal fluid is reduced in a first flow path through a pressure exchanger, and then increased in a second flow path in the same pressure exchanger. Benefits of the systems and methods of the present disclosure include more effective use of geothermal resources compared to conventional geothermal power systems.

It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

What is claimed is:

1. A method of operating a geothermal power system, comprising:
flowing a first fluid into a first inlet of a pressure exchanger;
flowing the first fluid from a first outlet of the pressure exchanger to a heat exchanger;
flowing the first fluid from the heat exchanger to a second inlet of the pressure exchanger;
flowing the first fluid from a second outlet of the pressure exchanger to a turbine coupled to a generator; and
generating electricity using the generator.

2. The method of claim 1, further comprising increasing a pressure of the first fluid in the first pressure exchanger as the first fluid transits from the second inlet to the second outlet.

3. The method of claim 1, further comprising reducing a pressure of the first fluid in the first pressure exchanger as the first fluid transits from the first inlet to the first outlet.

4. The method of claim 1, further comprising increasing a temperature of a second fluid at the heat exchanger using heat of the first fluid.

5. The method of claim 4, further comprising:
flowing the second fluid through an expander coupled to a generator; and
generating electricity using the generator.

6. The method of claim 1, further comprising:
producing the first fluid from a subterranean formation into a well;
flowing the first fluid from the well to the pressure exchanger;
flowing the first fluid from the turbine to a reservoir; and
pumping the first fluid from the reservoir back into the subterranean formation at the well.

7. The method of claim 1, further comprising:
producing the first fluid from a subterranean formation into a first well;
flowing the first fluid from the first well to the pressure exchanger;
flowing the first fluid from the turbine to a second well; and
injecting the first fluid into the subterranean formation at the second well.

8. A method of operating a geothermal power system, comprising:
simultaneously flowing a first fluid and a second fluid, wherein:
the first fluid passes through a pressure exchanger and then through a heat exchanger; and
the second fluid passes through the heat exchanger and then through the pressure exchanger;
transferring heat from the first fluid to the second fluid at the heat exchanger;
reducing a pressure of the first fluid at the pressure exchanger by increasing a pressure of the second fluid at the pressure exchanger;
flowing the second fluid from the pressure exchanger to an expander coupled to a generator;
operating the expander to reduce the pressure and a temperature of the second fluid; and
generating electricity using the generator.

9. The method of claim 8, further comprising producing the first fluid from a subterranean formation into a first well, and flowing the first fluid from the first well to the pressure exchanger.

10. The method of claim 9, further comprising flowing the first fluid from the heat exchanger into a second well, and injecting the first fluid back into the subterranean formation.

11. The method of claim 9, further comprising pumping the first fluid into the first well, and injecting the first fluid back into the subterranean formation.

12. The method of claim 11, further comprising flowing the first fluid from the heat exchanger to a reservoir prior to pumping the first fluid into the first well.

13. The method of claim 11, further comprising ceasing production of the first fluid from the first well prior to pumping the first fluid into the first well.

14. A geothermal power system, comprising:
a heat exchanger fluidically coupled to a pressure exchanger, wherein:
a first fluid enters the pressure exchanger at a first inlet, and transits through the pressure exchanger in a first fluid path from the first inlet to a first outlet;
the heat exchanger receives the first fluid from the first outlet of the pressure exchanger;
the pressure exchanger receives the first fluid from the heat exchanger at a second inlet of the pressure exchanger; and
the first fluid transits through the pressure exchanger in a second fluid path from the second inlet to a second outlet, the second fluid path separate from the first fluid path;
a turbine fluidically coupled to the second outlet of the pressure exchanger; and
a first generator coupled to the turbine.

15. The geothermal power system of claim 14, further comprising a binary cycle power plant configured to operate with a second fluid, the binary cycle power plant including:
the heat exchanger;
an expander fluidically coupled to the heat exchanger; and
a second generator coupled to the expander.

16. The geothermal power system of claim 14, wherein the turbine receives the first fluid from the second outlet of the pressure exchanger.

17. The geothermal power system of claim 16, further comprising a reservoir fluidically coupled to an outlet of the turbine.

18. The geothermal power system of claim 17, wherein the reservoir includes one of a pond, a tank, or a subterranean formation.

19. The geothermal power system of claim 16, further comprising a pump configured to inject the first fluid into a well, wherein the pump is downstream of the turbine.

20. The geothermal power system of claim 19, wherein the well provides the first fluid to the pressure exchanger.
